(19) United States
(12) Patent Application Publication
(10) Pub. No.: US 2003/0067378 A1
(43) Pub. Date: Apr. 10, 2003

(54) End-of-life indicator

(76) Inventor: David W. Baarman, Fenville, MI (US)

Correspondence Address: WARNER, NORCROSS & JUDD, IN RE: ALTICOR INC., INTELLECTUAL PROPERTY GROUP, 111 LYON STREET, N. W. STE 900, GRAND RAPIDS, MI, 49503-2489, US

(21) Appl. No.: 09/971,201

(22) Filed: Oct. 4, 2001

(51) Int. Cl. H01H 85/30; H01H 85/32

(52) U.S. Cl. 337/241; 337/242; 337/206

(57) ABSTRACT

This inventive end-of-live indicator is useful to provide notice of the degree of exhaustion of a consumable component of a device or appliance. The end-of-live indicator provides an indicator circuit, which upon receiving an electrical signal from a sensing circuit causes polarization of a simple transistor, thereby facilitating a current flow in the indicator circuit sufficient to exceed the current flow capacity of a fuse link. By exceeding the current flow capacity of the fuse link the current potential of the indicator circuit becomes zero. A plurality of indicator circuits permits indication of a plurality of degrees of exhaustion of the consumable component.

### FIELD OF THE INVENTION

The present invention relates to appliances or devices having a consumable component within the appliance.

### BACKGROUND OF THE INVENTION

Many consumer or commercial appliances incorporate a consumable component within the appliance. Examples of such consumables are water or air filtration elements, consumable water or air sanitation components, and ion exchangers. As a consequence of the neglect by omission of proper maintenance of installed appliances, taking a water treatment system for example, organic contaminants may pass through a saturated activated carbon filter.

For contaminants present below the taste and odor detection threshold of a water consumer, the consumer may not be aware that the targeted water contaminants have not been removed because of, for the chosen example: a saturated activated carbon filter. Consequently, a consumer may be confident they have taken steps to assure the health and safety of themselves, and others drinking from the same source, when in fact the health risk from the water contaminants of concern remain.

End-of-life indicators exist for appliances incorporating consumable components, specifically for water treatment system, such a system is disclosed by U.S. Pat. No. 5,698,091. The system there disclosed concerns a water flow actuated electrical reed switch, for example as taught by U.S. Pat. No. 5,070,220 to provide input for a signal to a microprocessor. The required microprocessor elevates the cost of the appliance.

U.S. Pat. No. 4,681,677 discloses an end-of-life indicator for a water filter system and an automatic shut-off of raw water upon exhaustion of consumable component (absorbant).

U.S. Pat. No. 5,127,555 discloses a an interlock to prevent operation of the appliance, a gasoline (petrol) dispensing pump, while a consumable component, a full-flow filter, is replaced.

End-of-life of a consumable component is also provided by the water treatment system disclosed by WO 00/78681. The system there disclosed provides a smart chip to record and transmit information to an electronics assembly. The smart chip and electronics of the integrated system add cost to the appliance.

The present invention provides an economical means of determining when a consumable component is exhausted, and a means of signaling consumers and/or parties responsible for maintenance that attention to the appliance is required in the form of regeneration or replacement of the consumable component. Further, the present invention provides a means to avoid a false sense of security in the appliance user by providing notice of exhaustion of a consumable component.

Under some circumstances, a signal that the consumable component is exhausted may not be sufficient to provide the safety that the consumers expect from, in the present example, a water treatment system. Although the end of useful life signal may indicate exhaustion of the consumable component, parties responsible for maintenance of such consumables may overlook, or elect to delay, or omit, replacement of consumable components. The effect for water treatment system users in the present example is that the water is consumed in the mistaken belief that the unhealthy components are not present.

What is needed to avoid omission of necessary replacement or regeneration of consumable components used by appliance systems is an economical means of interrupting the service provided by the appliance in order that the necessity to replace or regenerate the consumable component cannot be overlooked or ignored.

### SUMMARY OF THE INVENTION

This invention is an economical means to inform the user of an appliance that includes a consumable component that the component is approaching the end of its useful life. The invention is an economical means to discontinue operation of an appliance that includes a consumable component that has exhausted its useful life. The measured property to determine the degree of exhaustion of the consumable component is independent of the nature of the state of matter acted upon by the appliance. To explain, consider that the end-of-life flow termination disclosed in U.S. Pat. No. 4,681,677 requires a pressure differential across a filter media; end-of-life measurement device of the '677 patent requires separate schemes to consider exhaustion of consumable component (adsorbant) vs flow restriction caused by filter blockage. The indicator circuit according to the present invention is advantaged because the indicator circuit is independent of the exhaustion sensor.

### BRIEF DESCRIPTION OF THE FIGURE

FIG. 1 is a drawing of circuits of an indicator portion of an embodiment that implements the invention.

### DESCRIPTION OF THE INVENTION

Again using as an example of a consumable component of an appliance, an activated carbon filter for removal of contaminants in drinking water, such a filter can be incorporated in a water filtration apparatus such as described by U.S. Pat. No. 6,245,229 B1, incorporated herein by reference, or described by U.S. Pat. No. 5,698,091, also incorporated herein by reference.

The end of life indication is implemented when the consumable component is exhausted based on a measured property. Such a measured value may be, for example, hours of use, or to continue the example of an activated carbon filter, volume of treated water.

The volume of treated water may be an accumulation of internal flow rates stored on a microprocessor as suggested by WO 00/78681 A2, p. 11-12. The flow rate is determined by calibrating a flow meter. For example, a magnet imbedded within a blade caused to rotate by water flow. A Hall effect sensor senses the magnetic field resulting from the rotation of the magnet-containing blade. A smart chip may accumulate the signal generated by the Hall effect sensor. When the number of rotations of the magnet imbedded rotor corresponds to a level of exhaustion of the consumable component, activated carbon in this example, then the smart chip signals the indicator circuit.

The indicator circuit may indicate to the user that the consumable component is nearing exhaustion prior to halting operation of the appliance. Or, if the level of exhaustion of the consumable component determined for a first signal to the indicator circuit is one hundred percent exhausted, then the indicator circuit may halt operation of the appliance on the first, and only, signal from the indicator signal.

Alternatively, the user is provided with prior notification and an opportunity to service the appliance prior to the appliance shutting down by means of one or more additional indicator signals at selected levels of exhaustion at, for example: 75% and 90% exhaustion.

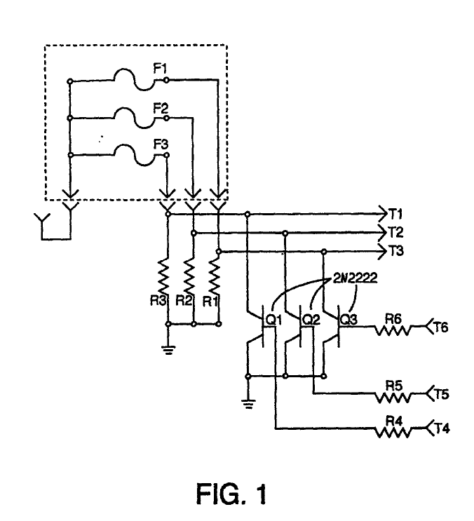

In an embodiment of an indicator circuit, FIG. 1 shows an economical circuit for receiving signals indicating three levels of exhaustion of the consumable component. The indicator circuit operates by receiving a signal at T4 from a sensor circuit. The signal received at terminal T4 (and T5 and T6 of the embodiment exemplified by FIG. 1) is from an exhausted sensor customized to measure an appropriate property of the consumable. The signal at T4 polarizes the transistor Q1 to permit current flow through a basic NPN transistor 2N2222 Q1 to ground. The flow of current through Q1 to ground is designed to exceed the current flow capacity of the fuse link F3 thereby interrupting the current potential at terminal T1.

Notice to the user that the consumable has exceeded the first selected threshold level of exhaustion may be provided by the absence of current potential at terminal T1. For example, if current supplied from terminal T1 operated a green light indicating the appliance was in a ready state, the interruption of the circuit at F3 would extinguish the green light.

The sequence repeats at a second selected level of exhaustion creating a second level of notice to the user. A second level signal from the exhaustion sensor is received at the indicator circuit at terminal T5. As with the signal indicating a first level of exhaustion, the signal at T5 permits current flow through a basic NPN transistor 2N2222 Q2 to ground. The flow of current through Q2 to ground exceeds the current flow capacity of the fuse link F2 thereby interrupting the current potential to terminal T2.

Notice to the user that the consumable has exceeded the second selected threshold level of exhaustion may be provided by the absence of current potential at terminal T2. For example, if current supplied from terminal T2 operated a yellow light indicating the appliance was operable but in need of service soon, the interruption of the circuit at F2 would extinguish the yellow light. The appliance may continue to operate with the yellow indicator light extinguished until the final level of exhaustion, in this explanation the third level of exhaustion, is reached.

Upon reaching the final level of exhaustion, the sequence repeats at the last selected level of exhaustion causing the service of the appliance to discontinue. A signal indicating the last level of exhaustion of the consumable is reached from the exhaustion sensor. The signal from the exhaustion sensor is received at the indicator circuit at terminal T6. As with the signal indicating a first level of exhaustion, the signal at T6 permits current flow through a basic NPN transistor 2N2222 Q3 to ground. The flow of current through Q3 to ground exceeds the current flow capacity of fuse F1 thereby interrupting the current potential to terminal T3.

An interrupted current flow at terminal T3 results in a discontinued service of the appliance. For example, if current supplied from terminal T3 provided operational energy to the appliance, either by a direct connection, or by indirect connection by means of a control relay connecting the appliance to a wall outlet, a loss of current potential at terminal T3 will result in a termination of operation of the appliance.

The illustration of the invention is provided with three indicator circuits. The invention, however, is not limited by the number of circuits providing notice of the degree of exhaustion. The number and sequence of the degree of exhaustion is limited only by the practical limitations of construction and utility to the user. Frequent monitoring of the condition of a consumable of an appliance may require ten, or more circuits.

Although the invention has been explained in terms of a water treatment device incorporating a consumable component, the scope of the invention is not thereby so limited. Rather the invention provides an economical means of providing users of appliances, from table top coffee makers for example incorporating water filtration/purification components, and smaller appliances of the household, to industrial scale processes of the largest size an economical means of providing notice to the user of the level of consumption of a consumable component and also preventing continued operation of the appliance after the consumable has been exhausted.

Non-limiting examples of appliances incorporating consumable components to which this invention may be applied include: a water treatment system as illustrated with activated carbon, or ion exchange resin; further a water treatment system comprising a full-flow filter, or a partial by-pass filter system such as a nano-filtration, or reverse-osmosis membrane separation where the degree of consumption may be based on a parameter such as pressure drop. Non-liquid examples of the application of the invention include gas filtration/purification such as air separation in to concentrated oxygen and non-oxygen fraction by means of membrane separations of pressure swing absorption processes where the degree of exhaustion of the consumable component (membrane or adsorbent) may be related to pressure differential measurements. Other gaseous applications include air purification appliances operating on the principle of ultra-violet destruction by of microbiological contaminants of air as is disclosed by U.S. Pat. Nos. 5,616,172 or 5,997,619. A further application includes a discrete indication to a user of the energy remaining in a battery.

An advantageous design feature is the inclusion of the indicator circuit as exemplified by in FIG. 1 within a replacement consumable component such as a screw-on filter cartridge. In such instance, it is not necessary to separately replace fuses or reset circuit breakers represented by the reference F in FIG. 1, as a part of the service of a consumable component. Rather, if the indicator circuit is integrated with the replacement consumable component with suitable electrical contacts to the appliance, then replacement of the consumable component also replaces the indicator circuit.

Applicant claims as his invention:

1. An end-of-life indicator comprising an indicator circuit including a fusible link that severs to provide notice to the user that a consumable component has exhausted its useful life.

2. The end-of-live indicator according to claim wherein the fusible link severs to further preclude operation of the device.

3. An end-of-life indicator comprising an indicator circuit including a plurality of fusible links that sever in sequence to provide notice to the user that a consumable component is approaching the end of its useful life.

4. The end-of-life indicator according to claim 3 wherein one of the plurality of fusible links severs to provide notice to the user that the consumable item has exhausted its useful life.

5. The end-of-life indicator according to claim 4 wherein one of the plurality of fusible links severs to preclude further operation of the appliance or device.

6. The end-of-life indicator according to claim 1 or claim 3 wherein the fusible link is a fuse of a circuit breaker.

7. The end-of-life indicator according to claim 3 wherein the indicator circuit is integrated with a replaceable consumable component.

8. The end-of-life indicator according to claim I wherein the indicator circuit is integrated with a replaceable consumable component.

9. The end-of-life indicator according to claim 4 wherein the indicator circuits contain from 2 to 10 circuits.

10. The end-of-life indicator according to claim 4 wherein the indicator circuits contain from 2 to 7 circuits.

11. The end-of-life indicator according to claim 4 wherein the indicator circuits contain from 2 to 4 circuits.

12. An end-of-life indicator comprising an indicator circuit including a plurality of fusible links that sever in sequence to provide notice to the user that a consumable component of a device is approaching the end of its useful life;
at least one of the plurality of fusible links being designed to sever when the consumable component has been substantially consumed; and
at least one of the plurality of fusible links being designed to sever when the consumable component has reached the end of its life.

13. The end-of-life indicator circuit of claim 9, wherein at least one of the plurality of fusible links designed to sever when the consumable component has reached the end of its life is also designed to prevent further operation of the device when severed.
